(19) United States
(12) Patent Application Publication
(10) Pub. No.: US 2026/0133888 A1
(43) Pub. Date: May 14, 2026

(54) PERFORMANCE MONITORING UNIT WORKLOAD SAMPLING WITH MINIMAL SYSTEM INTERFERENCES

(71) Applicant: Microsoft Technology Licensing, LLC, Redmond, WA (US)

(72) Inventors: Isaac HERNANDEZ LUNA, Barcelona (ES); Antonio JUAN HORMIGO, Barcelona (ES); Jairo BALART TARZAN, Barcelona (ES)

(21) Appl. No.: 18/948,044

(22) Filed: Nov. 14, 2024

(51) Int. Cl. G06F 11/34; G06F 9/54; G06F 11/30

(52) U.S. Cl. CPC G06F 11/3476; G06F 9/542; G06F 9/544; G06F 11/3024

(57) ABSTRACT

The present disclosure generally relates to sampling performance monitoring unit workloads with little to no system interference. Systems and methods described herein leverage specialized sampling controller hardware to define customized processor events that drive what data to sample, when the data should be sampled, how long the data should be sampled. Thus, by utilizing this specialized sampling controller hardware, the systems and methods described herein provide a flexible mechanism for gathering customized performance data from a performance monitoring unit. Additionally, the systems and methods described herein implement an uncacheable memory path that avoids existing cache stores associated with a processor. As such, the systems and methods described herein avoid polluting the existing cache stores and causing performance issues within the processor.

### BACKGROUND

Performance monitoring units (PMUs) are increasingly included in the microarchitecture of processing cores. Generally, a PMU is a specialized hardware component within a processing core (e.g., a CPU) that is designed to measure various performance metrics. For example, a PMU can count metrics such as instruction cycles, cache hits and misses, branch misses, and other microarchitectural events. By accessing these metrics, developers may optimize performance of the CPU by identifying bottlenecks and inefficiencies. As such, PMU data is often utilized by various tools and frameworks to profile and analyze system performance, and to provide insights that can help improve both hardware and software design.

PMU data, however, can be difficult to gather and utilize for various reasons. For example, PMU data is often too general to provide valuable insights. Further, general purpose PMUs often fail to provide any mechanism for dialing into the granularity of how data is gathered. In contrast, customized or specific-purpose PMUs often lack the flexibility necessary to be implemented across a wide variety of applications. As such, conventional approaches for gathering information using PMUs often fail to efficiently or accurately collect relevant metric data to accomplish desired purposes and tasks.

Moreover, PMUs often generate high levels of noise in connection with the CPU or other processing core that they are measuring. For example, typical PMUs may often cannibalize existing caches to store traces of metric data while an application is running on a CPU. Thus, bottlenecks are created when other processes need to cache data while the CPU is in operation. As such, a typical PMU may actually cause performance issues in the CPU whose performance it is monitoring.

The subject matter in the background section is intended to provide an overview of the overall context for the subject matter disclosed herein. The subject matter discussed in the background section should not be assumed to be prior art merely as a result of its mention in the background section. Similarly, a problem mentioned in the background section or associated with the subject matter of the background section should not be assumed to have been previously recognized in the prior art.

### BRIEF DESCRIPTION OF THE DRAWINGS

FIG. 1 illustrates an example overview of a digital environment where a PMU management system operates to flexibly and efficiently sample PMU workloads with minimal system interference in accordance with one or more embodiments.

FIG. 2 illustrates an example sampling controller utilized by the PMU management system in accordance with one or more embodiments.

FIG. 3 illustrates a schematic overview of how the PMU management system implements the sampling controller in connection with a PMU and an uncacheable store path in accordance with one or more embodiments.

FIG. 4 illustrates a schematic diagram of the features and functionality of the PMU management system in accordance with one or more embodiments.

FIG. 5 illustrates a series of acts for sampling PMU workloads with minimal system interferences in accordance with one or more embodiments.

FIG. 6 illustrates certain components that may be included within a computer system in accordance with one or more embodiments.

### DETAILED DESCRIPTION

The present disclosure relates to systems, methods, and computer-readable media for sampling customized performance monitoring unit (PMU) data with little to no system interference. As discussed above, existing PMU data gathering systems offer no mechanism for tailoring the gathering of PMU data to specific processor events. Thus, such systems are limited to whatever data the PMU was pre-configured to generate. Additionally, existing PMU data gathering systems typically utilize existing cache stores within the core where the PMU is located. By utilizing these cache stores, these systems often cause bottlenecks and other system slow-downs—thereby increasing performance issues within the processing core.

To remedy these deficiencies, the present disclosure describes a PMU management system that leverages specialized sampling controller hardware to define customized processor events that drive what data to sample, when the data should be sampled, and how long the data should be sampled. Thus, by utilizing this specialized sampling controller hardware, the PMU management system provides a flexible mechanism for gathering customized performance data from a PMU.

Moreover, the PMU management system further includes an uncacheable storage path that avoids existing cache stores. For example, the PMU management system holds PMU data in temporary trace buffers and then moves those PMU data traces to storage via the uncacheable storage path. By utilizing this path, the PMU management system leaves existing cache free to service applications running on the processor that the PMU is measuring. As such, the PMU management system has only minimal interference with the processor and its functionality—leading to fewer resource bottlenecks and slow-downs.

In one or more implementations, the methods and steps performed by the PMU management system reference multiple terms. For example, as referenced herein, a “processor,” “computer processing unit,” “CPU,” or “core” refers to a hardware circuit of logic gates and caches that performs the majority of the calculations and tasks that allow a computing device to function. Generally, a processor, CPU, or core carries out instructions from programs or applications by performing basic arithmetic, logic, control, and input/output operations.

As used herein, “CPU events” and/or “processor events” refer to specific activities or occurrences within a CPU, processor, or core that can be tracked and measured to analyze the processor's performance. CPU events may range from single signals that are detected in connection with data tracking mechanisms operating in conjunction with a CPU, processor, or core, such as a particular fault or signal that is detected or otherwise tracked. In one or more embodiments, CPU events refer to defined combinations of signals or data points that are detected in connection with operation of the CPU, processor, and/or core. Some non-limiting examples of CPU events include execution of an instruction, a cache hit and/or miss, a branch prediction, a data item read and/or write, and more.

In one or more embodiments, CPU events are tracked or otherwise detected by performance monitoring units (PMUs). As mentioned above, and as used herein, a “performance monitoring unit” or “PMU” is a hardware circuit that tracks various performance-related events, such as CPU cycles, cache hits and misses, branch predictions, and instructions executed, and so forth.

As used herein, a “PMU data trace” refers to a collection of PMU data that is transmitted together from a PMU to the PMU management system. In one or more embodiments, a PMU data trace includes event counts for specific events that the PMU management system has instructed the PMU to count. As discussed in greater detail below, in one or more embodiments, the PMU management system may accept PMU data traces from the PMU that are no larger than 64 bytes.

As used herein, the term “uncacheable data” describes a type of data utilized by the PMU management system that is not stored in any processor cache. Thus, an uncacheable buffer is temporary data storage that exists outside of the caches of a core being monitored by a PMU. Similarly, an uncacheable memory path refers to a path along which the PMU management system may move PMU data that exists outside of processor caches.

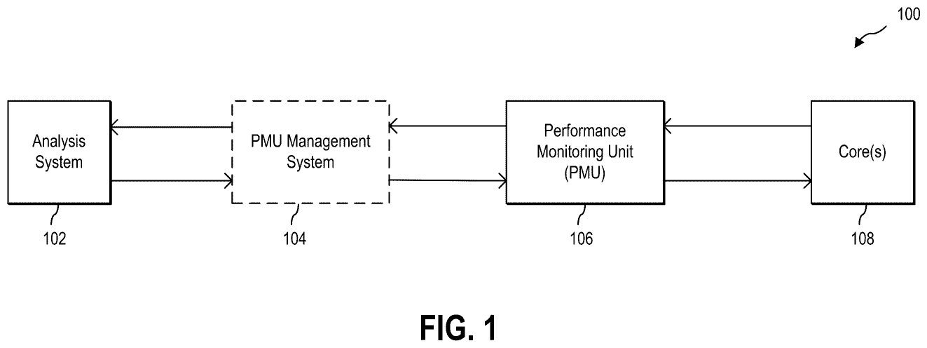

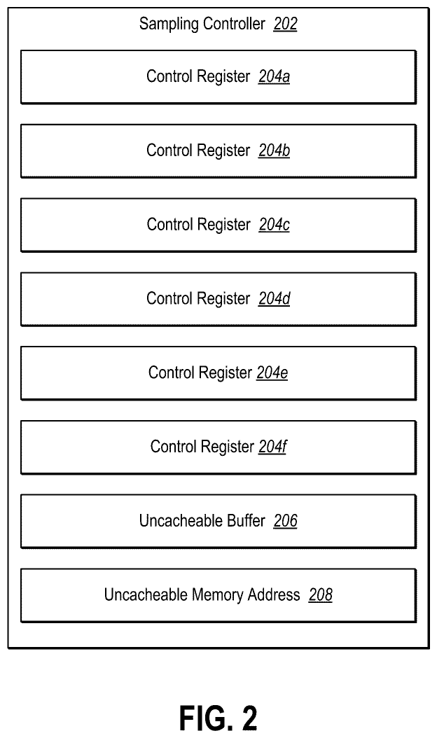

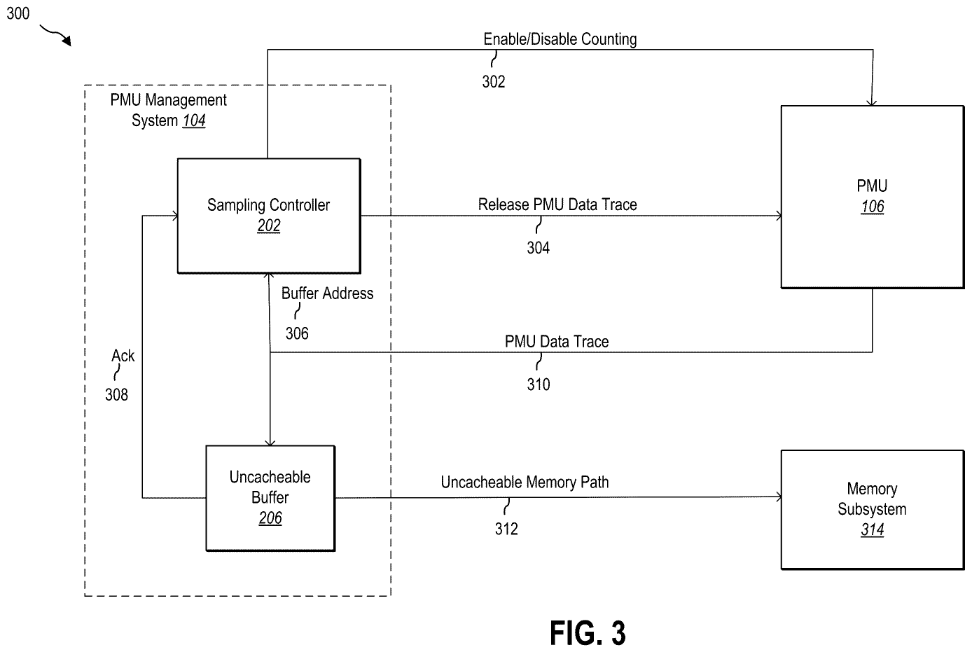

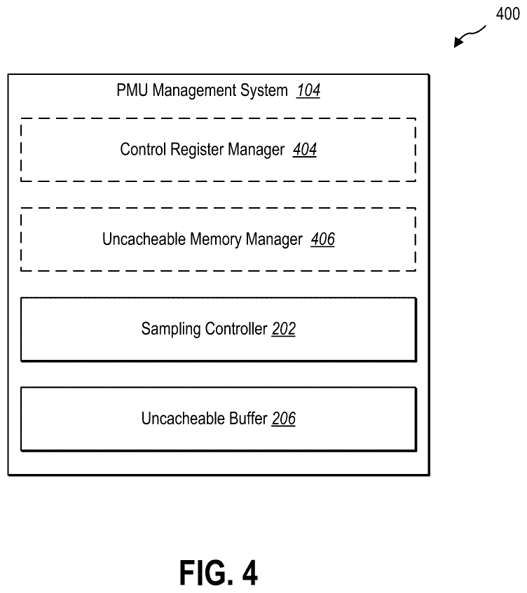

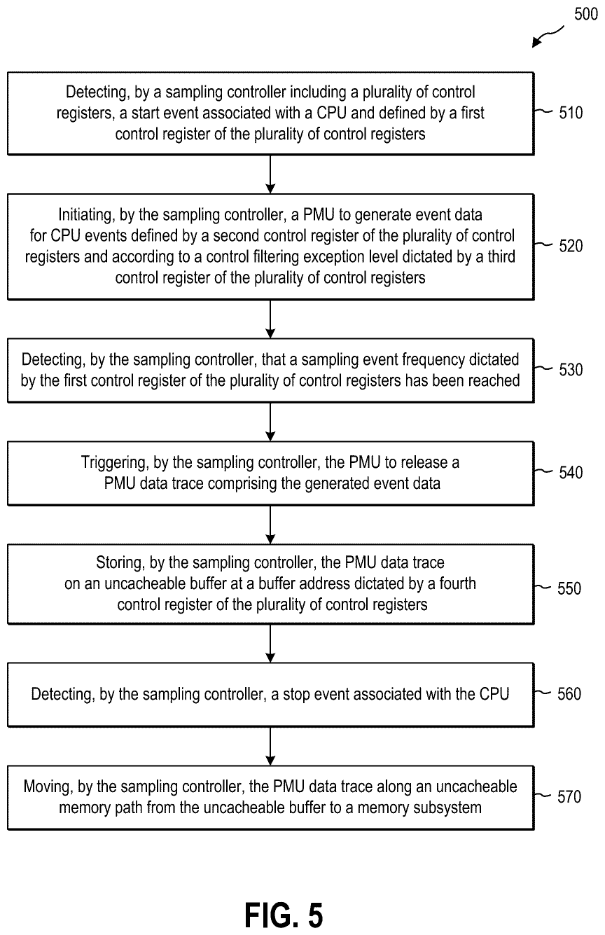

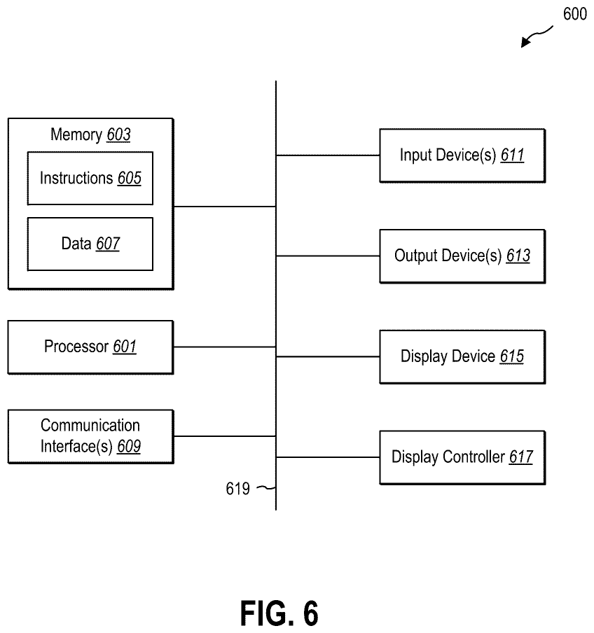

Additional details regarding example implementations of the PMU management system will now be discussed in connection with the following figures. To illustrate, FIG. 1 provides an example overview of a digital environment where the PMU management system operates to flexibly and efficiently sample PMU workloads with minimal system interference. FIG. 2 illustrates an example sampling controller utilized by the PMU management system. FIG. 3 illustrates a schematic overview of how the PMU management system implements the sampling controller in connection with a PMU and an uncacheable store path. FIG. 4 illustrates a schematic diagram of the features and functionality of the PMU management system. Additionally, FIG. 5 illustrates a series of acts for sampling PMU workloads with minimal system interferences. Finally, FIG. 6 illustrates an overview diagram of a computing system.

As just mentioned, FIG. 1 illustrates an example overview of a digital environment 100 where the PMU management system operates to flexibly and efficiently sample PMU workloads with minimal system interference. For example, as shown, a PMU management system 104 can include controlling software as well as hardware components that are operably connected to a performance monitoring unit (PMU) 106, which is operably connected to a core(s) 108. As mentioned above, in one or more embodiments, the core(s) 108 can include any type of processing unit such as a central processing unit (CPU), a graphics processing unit (GPU), a digital signal processor (DSP), a field-programmable gate array (FPGA), an application-specific integrated circuit (ASIC), a tensor processing unit (TPU), a microcontroller (MCU), etc. In some embodiments, the core(s) 108 may be a dual-core processor, a quad-core processor, and so forth.

In one or more embodiments, the PMU 106 is a specialized component that tracks various performance-related events in connection with the core(s) 108. Such events can include the execution of an instruction, a cache hit and/or miss, a branch prediction, a data item read and/or write, and more. In at least one embodiment, the PMU 106 includes a series of hardware counters that increment each time a particular event occurs. In one or more embodiments, the PMU management system 104 can control the operation of the PMU 106 by enabling and disabling the PMU 106. The PMU management system 104 can further instruct specific hardware counters within the PMU 106 to count CPU events while also controlling the control filtering exception level in the PMU 106. The PMU management system can also cause the PMU 106 to dump or release a PMU data trace along an uncacheable memory path.

As further shown in FIG. 1, the digital environment 100 can further include an analysis system 102. In one or more embodiments, the analysis system 102 accesses PMU data stored by the PMU management system 104 to perform various tasks. For example, the analysis system 102 can profile and/or debug an application running on the core(s) 108 based on the PMU data accessed via the PMU management system 104. Additionally, the analysis system 102 can identify resource bottlenecks and failures based on the PMU data accessed via the PMU management system 104. Moreover, the analysis system 102 can analyze performance characteristics of new hardware and/or software designed based on the PMU data access via the PMU management system 104.

As just mentioned, the PMU management system 104 leverages a specialized sampling controller to interact with the PMU 106. FIG. 2 illustrates an overview hardware schematic of such a sampling controller 202. In one or more embodiments, the sampling controller 202 is a specialized hardware logic block that controls the PMU 106 and connects to an uncacheable store path to generate a non-coherent uncacheable store. As shown in FIG. 2, the sampling controller 202 can include a series of control registers 204a, 204b, 204c, 204d, 204e, and 204f. Additionally, the sampling controller 202 can include an uncacheable buffer 206, and an uncacheable memory address 208. The functionality of each of these components will now be discussed in greater detail.

In one or more embodiments, the series of control registers 204a-204f enables the PMU management system 104 to operate the PMU 106 to flexibly gather performance data that is tailored to specific analysis goals. For example, while previous PMU systems were limited to receiving all of the data that a PMU was configured to collect, the PMU management system 104 utilizes the control registers 204a-204f of the sampling controller 202 to define specific events, event triggers, filtering exception levels, and more. It will be appreciated that while FIG. 2 shows an example in which the sampling controller 202 includes six (6) control registers 204a-f, other implementations may include additional or fewer control registers.

To illustrate, in one or more embodiments, the PMU management system 104 configures the control register 204a to define a current address to store a PMU data trace within the uncacheable buffer 206. For example, depending on how the remaining control registers 204b-204f are configured, the PMU management system 104 stores a PMU data trace dumped or released by the PMU 106. The PMU management system 104 can temporarily store the PMU data trace in the uncacheable buffer 206 at an address defined by the control register 204a. After each PMU data trace is stored in the uncacheable buffer 206, the PMU management system 104 can increment the address defined by the control register 204a such that the address held by the control register 204a always points to the next available memory address within the uncacheable buffer 206.

In one or more embodiments, the PMU management system 104 configures the control register 204b to define a start event and a sampling event frequency for that start event. For example, the control register 204b can define a start event including the execution of a particular instruction by the core(s) 108 and a sampling event frequency of ten-thousand (10,000) executions of that particular instruction by the core(s) 108. Thus, the sampling controller 202 can enable the PMU 106 upon first detecting the execution of the particular instruction by the core(s) 108. The sampling controller 202 can further instruct the PMU 106 to dump or release a PMU data trace to the uncacheable buffer 206 upon detecting the 10,000^{th} execution of that particular instruction. In one embodiment, the PMU management system 104 can configure the control register 204b to sample the start event randomly. In that embodiment, the control register 204b can indicate that a PMU data trace should be released after a predetermined number of random samples (e.g., each time the start event has been randomly sampled 100,000 times).

In one or more embodiments, the PMU management system 104 configures the control register 204c to define one or more events that should be tracked or counted. For example, the control registers 204c can hold a list of one or more event codes or event IDs that identify types of events. To illustrate, different types of events that can be counted by the PMU 106 may include, but are not limited to, executions of instructions, cache hits and/or misses, branch predictions, data item reads and/or writes, and so forth. Rather than receiving PMU data traces that include counts of any possible event, the control register 204c causes the PMU 106 to dump or release PMU data traces that are tailored to only the events that have been specified by the control register 204c.

In one or more embodiments, the PMU management system 104 configures the control register 204d to control the starting and stopping of event counting by the PMU 106. For example, the control register 204d can send a one or a zero to the PMU 106 to either enable or disable the PMU 106. When enabled, the PMU 106 counts events defined by the control register 204c. When disabled, the PMU 106 stops counting events defined by the control register 204c. In some embodiments, the PMU 106 may dump any existing count data upon receiving a zero from the control register 204d prior to becoming fully disabled.

In one or more embodiments, the PMU management system 104 configures the control register 204e to control filtering exception levels. For example, the control register 204e can instruct the PMU 106 to count the events defined by the control register 204c based on how those defined events were initiated. To illustrate, the control register 204e can instruct the PMU 106 to count defined events while the associated core(s) 108 is running an application in user mode. In another example, the control register 204e can instruct the PMU 106 to count defined events only while the core(s) 108 is running an application in system mode. In yet another example, the control register 204e can instruct the PMU 106 to count defined events while the core(s) 108 is running an application in a hybrid mode that includes either user mode or system mode or both. In some embodiments, an application running in user mode may be an application that receives user input during operation. In some embodiments, an application running in system mode may be an application that is not user-facing, but rather interacts with system components. In some embodiments, an application running in hybrid mode may include user-facing operations and system-facing operations.

In one or more embodiments, the PMU management system 104 configures the control register 204f to define a maximum size of the uncacheable buffer 206. For example, once the uncacheable buffer 206 is filled with PMU data traces based on the maximum size defined by the control register 204f, the PMU management system 104 can trigger a “TraceFull” event. Based on this event being triggered, the sampling controller 202 can move all of the data in the uncacheable buffer 206 to an uncacheable memory address 208 within a memory subsystem outside of the core(s) 108.

FIG. 3 illustrates an example process diagram showing how the PMU management system 104 samples PMU workload data tailored to specific events with minimal system interference. For example, in one or more embodiments, the PMU management system 104 configures the sampling controller 202 as discussed above. To illustrate, the PMU management system 104 programs the control register 204c of the sampling controller 202 with event codes or IDs for one or more events that should be counted. The PMU management system 104 further programs the control register 204e of the sampling controller 202 with the control filtering exception level (e.g., user mode, system mode, or hybrid mode). The PMU management system 104 additionally programs the control register 204b to define a start event and with a sampling event frequency (e.g., sample every 1,000 cache hits), or with a number of random samples (e.g., every 1,000 random samples). Finally, the PMU management system 104 programs the sampling controller 202 with the buffer address of the uncacheable buffer 206 and the maximum size of the uncacheable buffer 206 in the control register 204f.

With the sampling controller 202 configured, the sampling controller 202 can detect the start event defined by the control register 204b. For example, the sampling controller 202 can detect an occurrence of an event with an ID that matches that defined by the control register 204b. In response to detecting the start event, the sampling controller 202 can enable the PMU 106 by writing a predetermined value (e.g., a one (1)) along a control line 302 to the PMU 106. In one or more embodiments, the sampling controller 202 also transmits the one or more events defined by the control register 204c to the PMU 106 along the same control line 302. Additionally, the sampling controller 202 can transmit a control filtering exception level dictated by the control register 204e to the PMU 106 along the same control line 302.

In one or more embodiments, the PMU 106 generates event data for the one or more events defined by the control register 204c. For example, the PMU 106 generates event data including event counts (e.g., number of cache hits/misses), performance metrics (e.g., metrics derived from event counts such as instructions per cycle), and other profiling data. In at least one embodiment, the PMU 106 generates the event data further according to the control filtering exception level dictated by the control register 204e. For example, the control filtering exception level can cause the PMU 106 to count specific events when the core(s) 108 is operating in user mode, system mode, or a hybrid mode of both user mode and system mode.

As the PMU 106 is generating event data, the sampling controller 202 can monitor the sampling event frequency dictated by the control register 204b. In one or more embodiments, the sampling event frequency is tied to the start event. For example, if the start event is the execution of a particular instruction, the sampling event frequency may be one thousand executions of that same instruction. Once that instruction has been executed one thousand times (e.g., detected or otherwise tracked as having been executed one thousand times), the sampling controller 202 can determine that the defined sampling event frequency has been reached. Similarly, if the control register 204b indicates that the start event is sampling a particular data item and the sampling event frequency is one thousand random samples of that particular data item, the sampling controller 202 can determine that the sampling event frequency is reached when the data item has been randomly sampled one thousand times.

In response to determining that the sampling event frequency defined by the control register 204b has been reached, the sampling controller 202 can trigger the PMU 106 to release a PMU data trace by transmitting a release instruction along a control line 304. In one or more embodiments, the PMU 106 releases or dumps the PMU data trace including the generated event data (e.g., event counts and other metrics) for the events defined by the control register 204c. The sampling controller 202 can receive the PMU data trace along a control line 310.

In one or more embodiments, the sampling controller 202 stores the received PMU data trace in the uncacheable buffer 206 at a buffer address 306 dictated by the control register 204a. Once the sampling controller 202 stores the received PMU data trace, the sampling controller 202 can increment the buffer address 306 within the control register 204a by a predetermined amount (e.g., the size of the PMU data trace (64 bytes)). Thus, the sampling controller 202 ensures that the buffer address 306 points to the next available memory address in the uncacheable buffer 206. In at least one embodiment, the uncacheable buffer 206 can provide an acknowledgement 308 back to the sampling controller 202 to indicate that the received PMU data trace has been successfully stored.

The sampling controller 202 will continue to request releases of PMU data traces based on the sampling event frequency from the PMU 106 and storing the PMU data traces in the uncacheable buffer 206 until at least one of two events occur. For example, in one embodiment, the process described above continues until the maximum size of the uncacheable buffer 206 defined by the control register 204f is reached thereby triggering a “TraceFull” event. In response to determining a “TraceFull” event has occurred, the sampling controller 202 can disable the PMU 106 by transmitting a predetermined value (e.g., a zero (0)) along the control line 302 to the PMU 106.

In another embodiment, the process described above continues until a stop event is reached. For example, in response to determining that a stop event has occurred, the sampling controller 202 can disable the PMU 106 by transmitting a zero along the control line 302 to the PMU 106. To illustrate, the sampling controller 202 may determine that a stop event has occurred in response to determining that an application running on the core(s) 108 has terminated, in response to determining that a predetermined number of PMU data traces has been collected, in response to determining that a subroutine of an application running on the core(s) 108 has completed, and so forth.

Once the sampling controller 202 has determined that a “TraceFull” event or a stop event has occurred, the sampling controller 202 can move the PMU data traces from the uncacheable buffer 206 down an uncacheable memory path 312 to a memory subsystem 314. For example, the uncacheable memory path 312 avoids cache pollution associated with the core(s) 108 because it is wholly separate from the core(s) 108. As such, applications running on the core(s) 108 can utilize existing cache without PMU data traces taking up any space there. The uncacheable buffer 206 may be re-written the next time the PMU 106 is enabled by the sampling controller 202.

As mentioned above, and as shown in FIG. 4, the PMU management system 104 leverages the sampling controller 202 to collect PMU data at a high level of flexibility and granularity without interfering with the performance of the core(s) 108 that is being measured. FIG. 4 is a block diagram 400 of the PMU management system 104 operating within one or more memories of a computing device in connection with the sampling controller 202 and uncacheable buffer 206. As such, FIG. 4 provides additional detail with regard to these functions. For example, as shown in FIG. 4, PMU management system 104 can include a control register manager 404 and an uncacheable memory manager 406.

In certain implementations, the PMU management system 104 may represent one or more software applications, modules, or programs that, when executed by a computing device, may cause the computing device to perform one or more tasks. For example, and as will be described in greater detail below, one or more of the control register manager 404 and the uncacheable memory manager 406 may represent software stored and configured to run on one or more computing devices. Any of the control register manager 404 and/or the uncacheable memory manager 406 in FIG. 4 may also represent all or portions of one or more special purpose computers to perform one or more operations.

As mentioned above, and as shown in FIG. 4, the PMU management system 104 includes the control register manager 404. In one or more embodiments, the control register manager 404 programs, updates, and/or reprograms the components of the sampling controller 202. For example, the control register manager 404 can configure or program the control registers 204a-204f to include the data discussed above. Additionally, the control register manager 404 can configure or program the memory address range that defines the uncacheable buffer 206. The control register manager 404 can also configure or program the uncacheable memory address 208 to include a memory address within the memory subsystem 314 where the contents of the uncacheable buffer 206 will eventually be moved.

As mentioned above and as shown in FIG. 4, the PMU management system 104 also includes the uncacheable memory manager 406. In one or more embodiments, the uncacheable memory manager 406 maintains the uncacheable memory path 312 such that the operation of the PMU management system 104 does not come in contact with or otherwise pollute existing cache stores associated with the core(s) 108. As discussed above, the uncacheable memory manager 406 maintains the uncacheable buffer 206 and the path from the uncacheable buffer 206 to the memory subsystem 314 such that no interference is made with existing cache stores of the core(s) 108.

In one or more embodiments, a computing device running the PMU management system 104 can include one or more memories. For example, the one or more memories can generally represent any type or form of volatile or non-volatile storage device or medium capable of storing data and/or computer-readable instructions. In one example, the one or more memories may store, load, and/or maintain one or more components of the PMU management system 104. Examples of the one or more memories can include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

Additionally, as shown in FIG. 4, the computing device running the PMU management system 104 can include one or more physical processors. The one or more processor(s) generally represent any type or form of hardware-implemented processing units capable of interpreting and/or executing computer-readable instructions. In one implementation, the one or more physical processors may access and/or modify one or more components of the PMU management system 104. As with the other processors described herein, examples of the one or more physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

FIG. 5 illustrates an example series of acts 500 for sampling PMU workloads with minimal system interferences. While FIG. 5 illustrates acts according to one or more embodiments, alternative embodiments may omit, add to, reorder, and/or modify any of the acts shown in FIG. 5. The acts of FIG. 5 can be performed as part of a method. Alternatively, a non-transitory computer-readable medium can include instructions that, when executed by one or more processors, cause a computing device to perform the acts of FIG. 5. In still further embodiments, a system can perform the acts of FIG. 5.

As illustrated in FIG. 5, the series of acts 500 includes an act 510 of detecting, by a sampling controller (e.g., the sampling controller 202) including a plurality of control registers (e.g., the control registers 204a-204f), a start event associated with a CPU and defined by a first control register of the plurality of control registers (e.g., the control register 204b).

As further illustrated in FIG. 5, the series of acts 500 includes an act 520 initiating, by the sampling controller, a PMU to generate event data for CPU events defined by a second control register of the plurality of control registers (e.g., the control register 204c) and according to a control filtering exception level dictated by a third control register of the plurality of control registers (e.g., the control register 204e). For example, the CPU events defined by the second control register can include one or more of CPU cycles used, branch predictions made, cache hits, cache misses, instructions retired, memory reads, or memory writes. Additionally, the control filtering exception level can include at least one of a user mode, a system mode, or a hybrid mode.

In one or more embodiments, initiating the PMU to generate the event data defined by a second control register of the plurality of control registers and according to a filtering exception level dictated by a third control register of the plurality of control registers can include transmitting a first predetermined value to the PMU that enables operation of the PMU. Additionally, initiating the PMU to generate the event data defined by a second control register of the plurality of control registers and according to a filtering exception level dictated by a third control register of the plurality of control registers can further include transmitting one or more event codes for the CPU events defined by the second control register to the PMU to cause the PMU to count events associated with the one or more event codes.

As further illustrated in FIG. 5, the series of acts 500 includes an act 530 detecting, by the sampling controller, that a sampling event frequency dictated by the first control register of the plurality of control registers (e.g., the control register 204b) has been reached. For example, the sampling event frequency dictated by the first control register can include a predetermined number of times that the start event occurs in order for a PMU data trace to be released.

As further illustrated in FIG. 5, the series of acts 500 includes an act 540 triggering, by the sampling controller, the PMU to release a PMU data trace comprising the generated event data. In one or more embodiments, the PMU data trace has a maximum size of 64 bytes.

As further illustrated in FIG. 5, the series of acts 500 includes an act 550 storing, by the sampling controller, the PMU data trace on an uncacheable buffer (e.g., the uncacheable buffer 206) at a buffer address dictated by a fourth control register of the plurality of control registers (e.g., the control register 204a). In one or more embodiments, the series of acts 500 further includes, in response to storing the PMU data trace on the uncacheable buffer, incrementing the buffer address dictated by the fourth control register to indicate a next storage position in the uncacheable buffer. Additionally, the series of acts 500 can further include, prior to detecting the stop event associated with the CPU, detecting, while the PMU continues to generate additional event data for the CPU events defined by the second control register and according to the filtering exception level dictated by the third control register, that the sampling event frequency dictated by the first control register has been reached again, triggering the PMU to release a second PMU data trace comprising the additionally generated event data, and storing the second PMU data trace in the uncacheable buffer at the incremented buffer address.

As further illustrated in FIG. 5, the series of acts 500 includes an act 560 detecting, by the sampling controller, a stop event associated with the CPU. In some embodiments, the series of acts 500 further includes, in response to detecting the stop event, transmitting a second predetermined value to the PMU that disables operation of the PMU.

As further illustrated in FIG. 5, the series of acts 500 includes an act 570 moving, by the sampling controller, the PMU data trace along an uncacheable memory path from the uncacheable buffer to a memory subsystem. For example, the series of acts 500 can further include performing analysis on the PMU data trace in the memory subsystem to determine one or more metrics associated with the CPU.

FIG. 6 illustrates certain components that may be included within a computer system 600. One or more computer systems 600 may be used to implement the various devices, components, and systems described herein.

The computer system 600 includes a processor 601. The processor 601 may be a general-purpose single-or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 601 may be referred to as a central processing unit (CPU). Although just a single processor 601 is shown in the computer system 600 of FIG. 6, in an alternative configuration, a combination of processors (e.g., an ARM and DSP) could be used.

The computer system 600 also includes memory 603 in electronic communication with the processor 601. The memory 603 may be any electronic component capable of storing electronic information. For example, the memory 603 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

Instructions 605 and data 607 may be stored in the memory 603. The instructions 605 may be executable by the processor 601 to implement some or all of the functionality disclosed herein. Executing the instructions 605 may involve the use of the data 607 that is stored in the memory 603. Any of the various examples of modules and components described herein may be implemented, partially or wholly, as instructions 605 stored in memory 603 and executed by the processor 601. Any of the various examples of data described herein may be among the data 607 that is stored in memory 603 and used during execution of the instructions 605 by the processor 601.

A computer system 600 may also include one or more communication interfaces 609 for communicating with other electronic devices. The communication interface(s) 609 may be based on wired communication technology, wireless communication technology, or both. Some examples of communication interfaces 609 include a Universal Serial Bus (USB), an Ethernet adapter, a wireless adapter that operates in accordance with an Institute of Electrical and Electronics Engineers (IEEE) 802.11 wireless communication protocol, a Bluetooth^{®}wireless communication adapter, and an infrared (IR) communication port.

A computer system 600 may also include one or more input devices 611 and one or more output devices 613. Some examples of input devices 611 include a keyboard, mouse, microphone, remote control device, button, joystick, trackball, touchpad, and lightpen. Some examples of output devices 613 include a speaker and a printer. One specific type of output device that is typically included in a computer system 600 is a display device 615. Display devices 615 used with embodiments disclosed herein may utilize any suitable image projection technology, such as liquid crystal display (LCD), light-emitting diode (LED), gas plasma, electroluminescence, or the like. A display controller 617 may also be provided, for converting data 607 stored in the memory 603 into text, graphics, and/or moving images (as appropriate) shown on the display device 615.

The various components of the computer system 600 may be coupled together by one or more buses, which may include a power bus, a control signal bus, a status signal bus, a data bus, etc. For the sake of clarity, the various buses are illustrated in FIG. 6 as a bus system 619.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for sampling PMU workloads with minimal system interferences comprising:
detecting, by a sampling controller comprising a plurality of control registers, a start event associated with a CPU and defined by a first control register of the plurality of control registers;
initiating, by the sampling controller, a PMU to generate event data for CPU events defined by a second control register of the plurality of control registers and according to a control filtering exception level dictated by a third control register of the plurality of control registers;
detecting, by the sampling controller, that a sampling event frequency dictated by the first control register of the plurality of control registers has been reached;
triggering, by the sampling controller, the PMU to release a PMU data trace comprising the generated event data;
storing, by the sampling controller, the PMU data trace on an uncacheable buffer at a buffer address dictated by a fourth control register of the plurality of control registers;
detecting, by the sampling controller, a stop event associated with the CPU; and
moving, by the sampling controller, the PMU data trace along an uncacheable memory path from the uncacheable buffer to a memory subsystem.

2. The method as recited in claim 1, wherein initiating the PMU to generate the event data defined by a second control register of the plurality of control registers and according to a filtering exception level dictated by a third control register of the plurality of control registers comprises transmitting a first predetermined value to the PMU that enables operation of the PMU.

3. The method as recited in claim 1, wherein initiating the PMU to generate the event data defined by a second control register of the plurality of control registers and according to a filtering exception level dictated by a third control register of the plurality of control registers further comprises transmitting one or more event codes for the CPU events defined by the second control register to the PMU to cause the PMU to count events associated with the one or more event codes.

4. The method as recited in claim 2, further comprising, in response to detecting the stop event, transmitting a second predetermined value to the PMU that disables operation of the PMU.

5. The method as recited in claim 1, wherein the CPU events defined by the second control register comprise one or more of CPU cycles used, branch predictions made, cache hits, cache misses, instructions retired, memory reads, or memory writes.

6. The method as recited in claim 1, wherein the sampling event frequency dictated by the first control register comprises a predetermined number of times that the start event occurs in order for a PMU data trace to be released.

7. The method as recited in claim 1, wherein the control filtering exception level comprises at least one of a user mode, a system mode, or a hybrid mode.

8. The method as recited in claim 1, further comprising, in response to storing the PMU data trace on the uncacheable buffer, incrementing the buffer address dictated by the fourth control register to indicate a next storage position in the uncacheable buffer.

9. The method as recited in claim 8, further comprising, prior to detecting the stop event associated with the CPU:
detecting, while the PMU continues to generate additional event data for the CPU events defined by the second control register and according to the filtering exception level dictated by the third control register, that the sampling event frequency dictated by the first control register has been reached again;
triggering the PMU to release a second PMU data trace comprising the additionally generated event data; and
storing the second PMU data trace in the uncacheable buffer at the incremented buffer address.

10. The method as recited in claim 1, further comprising performing analysis on the PMU data trace in the memory subsystem to determine one or more metrics associated with the CPU.

11. A system comprising:
at least one processor;
a PMU configured to monitor the at least one processor;
a sampling controller configured to receive data from the PMU and comprising a plurality of control registers;
an uncacheable memory path leading from the sampling controller to one or more memory subsystems; and
instructions stored in the sampling controller, the instructions being executable to:
initiate, in response to detecting a start event associated with the at least one processor and defined by a first control register of the plurality of control registers, a PMU to generate event data for processor events defined by a second control register of the plurality of control registers and according to a control filtering exception level dictated by a third control register of the plurality of control registers;
detect that a sampling event frequency dictated by the first control register of the plurality of control registers has been reached;
trigger the PMU to release a PMU data trace comprising the generated event data;
store the PMU data trace on an uncacheable buffer at a buffer address dictated by a fourth control register of the plurality of control registers; and
move, in response to detecting a stop event associated with the at least one processor, the PMU data trace from the uncacheable buffer along an uncacheable memory path to a memory subsystem.

12. The system as recited in claim 11, wherein the instructions stored in the sampling controller are further executable to initiate the PMU to generate event data by transmitting a first predetermined value to the PMU that enables operation of the PMU.

13. The system as recited in claim 12, wherein the instructions stored in the sampling controller are further executable to, in response to detecting the stop event associated with the at least one processor, transmit a second predetermined value to the PMU that disables operation of the PMU.

14. The system as recited in claim 11, wherein the processor events defined by the second control register comprise one or more of CPU cycles used, branch predictions made, cache hits, cache misses, instructions retired, memory reads, or memory writes.

15. The system as recited in claim 14, wherein the sampling event frequency dictated by the first control register comprises a predetermined number of times that the start event occurs in order for a PMU data trace to be released.

16. The system as recited in claim 11, wherein the control filtering exception level comprises at least one of a user mode, a system mode, or a hybrid mode.

17. The system as recited in claim 11, wherein the instructions stored in the sampling controller are further executable to, in response to storing the PMU data trace on the uncacheable buffer, increment the buffer address dictated by the fourth control register to indicate a next storage position in the uncacheable buffer.

18. The system as recited in claim 17, wherein the instructions stored in the sampling controller are further executable to, prior to detecting the stop event associated with the at least one processor:
detect, while the PMU continues to generate additional event data for the processor events defined by the second control register and according to the filtering exception level dictated by the third control register, that the sampling event frequency dictated by the first control register has been reached again;
trigger the PMU to release a second PMU data trace comprising the additionally generated event data; and
store the second PMU data trace in the uncacheable buffer at the incremented buffer address.

19. The system as recited in claim 11, wherein the instructions stored in the sampling controller are further executable to perform analysis on the PMU data trace in the memory subsystem to determine one or more metrics associated with the at least one processor.

20. A method for sampling PMU workloads with minimal system interferences comprising:
initiating, by a sampling controller comprising a plurality of control registers, a PMU to generate event data for processor core events defined by a first control register of the plurality of control registers and according to a control filtering exception level dictated by a second control register of the plurality of control registers;
detecting, by the sampling controller, that a sampling event frequency dictated by a third control register of the plurality of control registers has been reached;
storing, by the sampling controller, a PMU data trace released by the PMU and comprising the generated event data on an uncacheable buffer; and
moving, by the sampling controller, the PMU data trace along an uncacheable memory path to a memory subsystem in response to the PMU becoming disabled.
